(19) United States
(12) Patent Application Publication
(10) Pub. No.: US 2016/0340095 A1
(43) Pub. Date: Nov. 24, 2016

(54) SYNTHETIC EGG

(71) Applicant: Wal-Mart Stores, Inc., Bentonville, AR (US)

(72) Inventor: Charles Dewayne Ritter, Bentonville, AR (US)

(21) Appl. No.: 15/137,282

(22) Filed: Apr. 25, 2016

Related U.S. Application Data
(60) Provisional application No. 62/165,402, filed on May 22, 2015.

(51) Int. Cl. B65D 65/46; B65D 85/60; A23G 3/34; B65B 1/02

(52) U.S. Cl. CPC B65D 65/466; B65B 1/02; B65D 85/60; A23G 3/343; A23V 2002/00

(57) ABSTRACT

Provided is a synthetic egg. A synthetic egg includes an egg shaped unitary body formed of a synthetic biodegradable material. The unitary body includes an inner volume. An aperture extends through an end of the unitary body and provides accesses to the inner volume of the unitary body. A filling material is inserted within the inner volume through the aperture. The filling material may include confetti, candy, a toy and the like. The unitary body is breakable into a plurality of non-uniform pieces and the filling material is accessed after insertion within the inner volume in response to breaking the unitary body into a plurality of non-uniform pieces. The synthetic biodegradable material may include a starch based biodegradable material.

### RELATED APPLICATION

This application claims priority to U.S. Provisional Patent Application Ser. No. 62/165,402 to Wal-Mart Stores Inc., filed May 22, 2015 and entitled “Synthetic Egg”, which is hereby incorporated entirely herein by reference.

### FIELD OF THE INVENTION

The invention relates generally to egg shaped product, and more specifically, to a synthetic biodegradable egg for filling with a filling material and a method of manufacturing the same.

### BACKGROUND

Confetti eggs, often referred to as cascarones, are products used in festive occasions and celebrations. Confetti eggs are forms of real eggs, such as chicken eggs, where in the shell of the egg is cracked to form a hole on one end of the eggs. The contents of the egg including the egg yolk and egg whites are emptied from within the egg. The egg must then be cleaned and decorated and finally dried. After the egg is dried, it can be filled with confetti or a small toy. Sometimes, the hole is then cover by tissue paper glued over the hole. The confetti eggs are then typically cracked over the head of another person to shower him or her with the confetti held within the confetti egg. Concerns arise as the short supply of confetti eggs because of limited availability of whole empty real egg shells for the creation of confetti eggs. Additionally, there is a health concern regarding proper cleaning of the eggs to avoid the potential salmonella poisoning.

### BRIEF SUMMARY

In one aspect, provided is a synthetic egg comprising: an egg shaped unitary body formed of a synthetic biodegradable material, the unitary body comprising an inner volume; an aperture extending through an end of the unitary body, wherein the aperture accesses the inner volume of the unitary body; and a filling material inserted within the inner volume through the aperture, wherein the unitary body is breakable into a plurality of non-uniform pieces and the filling material is accessed after insertion within the inner volume in response to breaking the unitary body into a plurality of non-uniform pieces.

In another aspect, provided is a method of manufacturing a synthetic egg, the method comprising: providing a starch based biodegradable material; and forming a synthetic egg by a molding process using the starch based biodegradable material.

In another aspect, provided is a synthetic egg comprising: an egg shaped unitary body formed of a synthetic starch based biodegradable material, the unitary body comprising an inner volume; an aperture extending through an end of the unitary body, wherein the aperture accesses the inner volume of the unitary body; and a filling material inserted within the inner volume through the aperture, wherein the unitary body is breakable into a plurality of non-uniform pieces and the filling material is accessed after insertion within the inner volume in response to breaking the unitary body into a plurality of non-uniform pieces.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is perspective view of a synthetic egg, in accordance with some embodiments.

FIG. 2 is a side view of a synthetic egg, in accordance with some embodiments.

FIG. 3 is a section view of a synthetic egg taken along line 3-3 of FIG. 2, in accordance with some embodiments.

FIG. 4 is a flow diagram illustrating a method for manufacturing a synthetic egg, in accordance with some embodiments.

### DETAILED DESCRIPTION

Many people consider confetti eggs as a necessity during certain celebrations, such as birthdays, Easter, Halloween, Cinco de Mayo, day of the Dead, Carnival, weddings and the like. The use is more prevalent in Latin American cultures, but is becoming more popular in other cultures in countries such as, but not limited to, the United States because of the many different cultures and ethnicities that are found within the cities and towns of the country. The use of real eggs is of importance because of how they crack to shower the confetti on people and further because real egg shells are biodegradable making them environmentally friendly.

Conventional confetti eggs are increasingly difficult to obtain. This is due in part to the limited supply of whole empty real egg shells that have been properly cleaned and are useable for confetti eggs. Additionally, because of the use of real whole egg shells, the confetti eggs must be filled by hand and thereby eliminating the possibility of mass production of confetti eggs.

The present inventive concept provides a synthetic egg that is formed with an inner volume or cavity that can be filled. The synthetic egg in accordance with some embodiments includes an egg shaped unitary body formed of a synthetic biodegradable material. The unitary body comprising an inner volume and an aperture extending through an end of the unitary body to provide access to the inner volume of the unitary body. The synthetic egg may also comprise a filling material inserted within the inner volume through the aperture. The unitary body is breakable into a plurality of non-uniform pieces and the filling material is accessed after insertion within the inner volume in response to breaking the unitary body into a plurality of non-uniform pieces. The synthetic egg is formed of a synthetic biodegradable material allowing for an environmentally friendly product when used and further, the synthetic material also allows the unitary body to crack in a manner similar to the cracking of a real egg shell. This provides for the proper showering of confetti or other filling material over another person.

Further, the synthetic egg in accordance with some embodiments must provide the strength sufficient to allow for non-breaking of the synthetic unitary body in storage and under load of multiple cartons of eggs stacked on top of the carton holding a plurality of eggs, such as a dozen eggs in a conventional egg carton. This ensures that the synthetic eggs will not crack under the forces present during shipping of mass produced synthetic eggs.

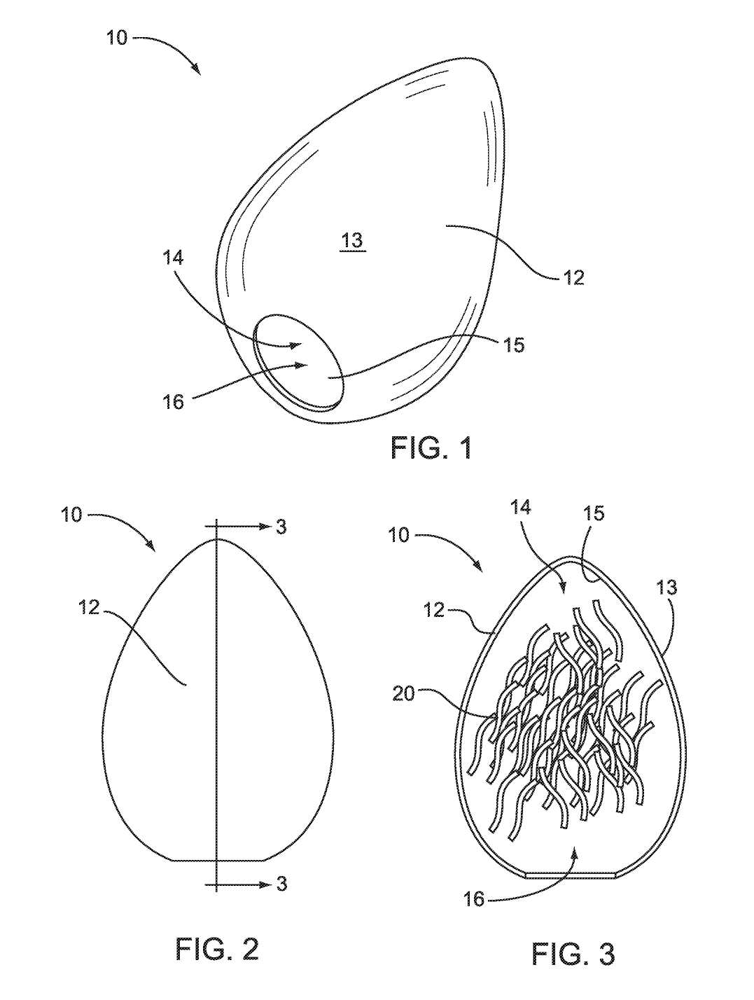

FIGS. 1-3 are illustrative views of a synthetic egg 10 in accordance with some embodiments of the present inventive concepts. Synthetic egg 10 may include an egg shaped unitary body 12, an inner volume 14 and an aperture 16.

The unitary body 12 may be formed of a synthetic biodegradable material. For example, and without limitation, the biodegradable material may include a starch based material that dissolves when exposed to the natural elements. This allows for the synthetic egg 10 that is used in accordance with use of some embodiments of the present invention to be left on the ground and there degrade as other biodegradable material does, much like a real egg shell. In embodiments, the unitary body 12 formed of synthetic biodegradable material may dissolve in approximately 4 months to 1 year. In other embodiments, the synthetic biodegradable material may dissolve in less than 120 days. In other embodiments, the synthetic biodegradable material may dissolve in approximately 90 to 120 days. The synthetic biodegradable material may also allow the unitary body 12 to be cracked or break into a plurality of non-uniform pieces. In other words, the synthetic biodegradable material unitary body 12 will crack in a manner similar to a real eggshell.

The unitary body 12 may have a thickness similar to that of a natural, real egg. The similar thickness of the unitary body 12 replicates the feel of a natural egg and further provides similar durability.

The inner volume 14 may be defined within the unitary body 12. The unitary body 12 may have an outer surface 13 an inner surface 15. The inner volume 14 is bounded by the inner surface 15 of the unitary body 12. The aperture 16 extends through an end of the unitary body 12. For example, the aperture 16 may extend through outer surface 12 and inner surface 15 of the unitary body 12 into the inner volume 14. The aperture 16 provides access to the inner volume.

The inner volume 14 of the unitary body 12 may then be filled with a filling material 20. In some embodiments, the filling material is confetti. In other embodiments, the filling material may be other objects, such as, but not limited to toys, candy, a photo, charms and any other material that is desired to be within the inner volume 14.

In embodiments, the synthetic egg 10 may be prefilled with filling material 20. For example, the synthetic egg 10 may be sold in packaging similar to a natural real egg, such as an egg carton. The packaging may include similar quantities, such as, six synthetic eggs 10, twelve synthetic eggs 10, 18 synthetic eggs and the like. The thickness of the unitary body 12 provides the durability and strength to allow a plurality of synthetic egg 10 packaging to be stacked without breaking of any of the synthetic eggs 10 within any one package. In some embodiments, the synthetic egg 10 that is prefilled may include a removable cover, wherein the removable cover is coupled to the unitary body 12 to cover aperture 16 and prevent filling material 20 from inadvertently falling out from within the inner volume 14.

In other embodiments, the synthetic eggs 10 may be provided or sold with no filling material 20 within the inner volume 14. The synthetic egg 10 may then be filled with any filling material 20 that the user desires to be within the synthetic egg 10.

In some embodiments, the synthetic eggs 10 may be provided with decorations already applied. In other embodiments, the synthetic biodegradable material forming the synthetic egg 10 may be decorated by typical means, including coloring, painting, dyeing, applying adhesive decorations and the like.

In use, a user may take a synthetic egg 10 filled with the filling material and the break the synthetic egg 10. The synthetic biodegradable material forming the unitary body 12 of the synthetic egg 10 cracks in a similar fashion to a natural, real egg. The cracking to the unitary body 12 exposes the inner volume 14 and releases the filling material 20 stored within the inner volume 14. This may be performed by cracking the synthetic egg 10 on the head of another person to allow filling material, such as confetti to be distributed on the other person. Other filling material 20 may be used based on the event or celebration for which the synthetic egg 10 may be used with.

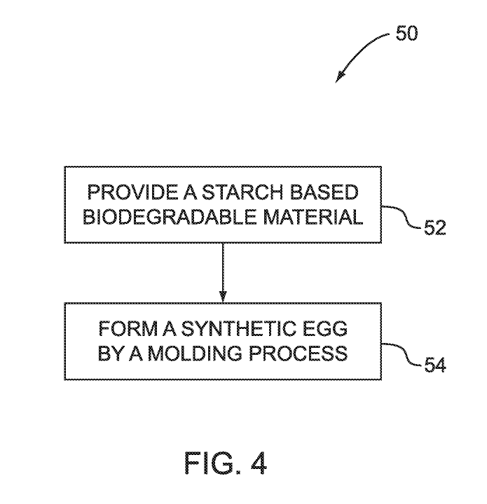

Referring to the drawings, FIG. 4 depicts a method 50 of manufacturing a synthetic egg, in accordance with embodiments of the present invention. The method 50 may be initiated at block 52, by a manufacturer providing a starch based biodegradable material. Providing a starch based biodegradable material may include mixing the component parts. The mixing of the component parts may be performed at the manufacturing facility or in another facility and shipped to the manufacturing facility. In other embodiments, providing a starch based biodegradable material may include purchasing the starch based biodegradable material from another party.

At block 54 of the method 50, the manufacturer may then form a synthetic egg 10 by blow molding. Blow molding may include the formation of a unitary body 12 of the synthetic egg 10 by providing a mold that includes the egg shape. The general blow molding process includes placing the synthetic biodegradable material within the bold and forcing air to place the material against surface of the mold. Blow molding includes the use of heated synthetic biodegradable material and is then cooled after blowing the material into the mold to obtain the egg shape and form the unitary body 12 with an aperture 16 extending through the unitary body 12 as accessing an inner volume 14. The unitary body 12, after creation with the mold may then be cooled to obtain the desired rigidity.

The type of blow molding process may include any available form of blow molding. It provides means for forming a synthetic egg 10 quickly and efficiently. Blow molding allows for the creation of the synthetic egg 10 as a unitary body 12 with an inner volume 14.

The method 50 of manufacturing the synthetic egg 10 may also include filling the inner volume 14 with filling material 20. The method 50 may also include decorating the unitary body 12 of the synthetic egg 10. The decorations may be thematic based on particular common events, such as weddings, birthdays, New Year celebrations, Cinco de Mayo, Halloween, Christmas, Fourth of July and any other holiday event and the like.

The method 50 may also include sealing the aperture 16 to retain the filling material 20 within the inner volume 14 of the unitary body 12. The seal provides an inhibition to the filling material inadvertently falling out of the synthetic egg 10.

While the invention has been shown and described with reference to specific preferred embodiments, it should be understood by those skilled in the art that various changes in form and detail may be made therein without departing from the spirit and scope of the invention as defined by the following claims.

What is claimed is:

1. A synthetic egg comprising:
an egg shaped unitary body formed of a synthetic biodegradable material, the unitary body comprising an inner volume;
an aperture extending through an end of the unitary body, wherein the aperture accesses the inner volume of the unitary body; and
a filling material inserted within the inner volume through the aperture, wherein the unitary body is breakable into a plurality of non-uniform pieces and the filling material is accessed after insertion within the inner volume in response to breaking the unitary body into a plurality of non-uniform pieces.

2. The synthetic egg of claim 1, wherein the unitary body is a thin material having a thickness similar to a thickness of a natural egg.

3. The synthetic egg of claim 1, wherein the filling material is confetti.

4. The synthetic egg of claim 3, wherein the confetti is biodegradable.

5. The synthetic egg of claim 1, wherein filling material is candy.

6. The synthetic egg of claim 1, wherein the synthetic biodegradable material comprises a starch based material.

7. A method of forming a synthetic egg, the method comprising:
providing a starch based biodegradable material; and
forming a synthetic egg by a molding process using the starch based biodegradable material.

8. The method of claim 7, wherein the molding process is a blow molding process.

9. The method of claim 7, further comprising filling an inner volume of the synthetic egg with filling material.

10. The method of claim 7, further comprising decorating a unitary body of the synthetic egg.

11. A synthetic egg comprising:
an egg shaped unitary body formed of a synthetic starch based biodegradable material, the unitary body comprising an inner volume;
an aperture extending through an end of the unitary body, wherein the aperture accesses the inner volume of the unitary body; and
a filling material inserted within the inner volume through the aperture, wherein the unitary body is breakable into a plurality of non-uniform pieces and the filling material is accessed after insertion within the inner volume in response to breaking the unitary body into a plurality of non-uniform pieces.

12. The synthetic egg of claim 1, wherein the unitary body is a thin material having a thickness similar to a thickness of a natural egg.

13. The synthetic egg of claim 1, wherein the filling material is confetti.

14. The synthetic egg of claim 3, wherein the confetti is biodegradable.

15. The synthetic egg of claim 1, wherein filling material is candy.
